(19) United States
(12) Patent Application Publication
(10) Pub. No.: US 2011/0283629 A1
(43) Pub. Date: Nov. 24, 2011

(54) High Strength Diamond-SiC Compacts and Method of Making Same

(75) Inventor: Thomas Charles Easley, Bexley, OH (US)

(73) Assignee: DIAMOND INNOVATIONS, INC., Worthington, OH (US)

(21) Appl. No.: 13/111,333

(22) Filed: May 19, 2011

Related U.S. Application Data
(60) Provisional application No. 61/346,235, filed on May 19, 2010.

(51) Int. Cl. B24D 3/04; B24D 18/00; B01J 3/06

(52) U.S. Cl. 51/309; 51/307

(57) ABSTRACT

The present disclosure provides a silicon carbide (SiC) bonded diamond compact having less than about 2 weight % unreacted Si and less than about 1 weight % graphite, as well as processes for making the same.

### RELATED APPLICATIONS

This application claims the benefit of U.S. Provisional Application No. 61/346,235 filed May 19, 2010.

### TECHNICAL FIELD AND INDUSTRIAL APPLICABILITY

The present disclosure provides a process/method of making a diamond compact having low levels of unreacted silicon and graphite. The present disclosure further includes diamond compacts made by the novel process disclosed herein, as well as tools utilizing the diamond compact made by the novel process.

### BACKGROUND OF THE INVENTION

Diamond compacts are often comprised of about 85% or more by volume of diamond grains that are bonded to one another at their points of contact. These compacts (referred to hereafter as polycrystalline diamond or PCD) most frequently also contain about 15% by volume or less of a catalyst metal, such as Co or Fe. These diamond compacts are often formed as 0.5 to 5 mm thick layers attached to WC substrates, or as solid, free-standing bodies. Forming these diamond compacts requires operating pressures in excess of 55 kBar.

U.S. Pat. No. 5,010,043 (“the '043 patent”), for example, discloses a method for making SiC bonded diamond compacts with sufficiently high degrees of abrasiveness, hardness, and mechanical strength so as to permit the compacts to be employed for the cutting, machining, milling, drilling, grinding, and working of hard and ultra hard materials, including advanced ceramics such as silicon carbide, boron carbide, silicon nitride, sialons, alumina, partially stabilized zirconia and beryllia, metallic materials such as tungsten carbide, titanium carbide, titanium boride, and high temperature nickel and cobalt based alloys, and very hard natural minerals and rocks such as precious and semi-precious gems, quartzite, granite, and banded iron formations.

The '043 patent discloses that the SiC bonded diamond compacts described therein comprise about 2% by weight unreacted silicon, about 23% SiC, and a measurable amount of graphite that is substantially greater than zero, but less than 1% by weight. The balance of the SiC bonded diamond compact, about 72% to about 76%, is diamond.

The compacts of the '043 patent are produced at preferred reaction pressures of about 10 to about 40 kBar and at preferred reaction temperatures of 1400° C. to 1600° C. for durations of 10 to 30 minutes. The '043 patent discloses that temperatures of up to 1800° C. can be used for about 3-5 minutes to produce a more complete reaction of Si to SiC, but that at this temperature, graphite tends to form in excess of the desired amount.

### SUMMARY OF THE INVENTION

The present disclosure describes a SiC bonded diamond compact having less than about 1 weight % residual graphite and less than about 2 weight % unreacted Si, and a process for preparing the diamond compact.

In particular embodiments, the present disclosure provides a process for preparing a silicon carbide (“SiC”) bonded diamond compact, the process comprising sintering a mixture, the mixture including diamond, silicon (Si), and, optionally, at least one component selected from the group of Si₃N₄, AlN, hBN, and combinations thereof, wherein the sintering takes place at a pressure of about 10 to about 80 Kbar; at a temperature of from about 1600° C. to about 1800° C.; and wherein the sintering takes place for at least about 10 minutes.

In a particular embodiment, the mixture is in contact with a mass of solid or powered Si during the sintering. In certain embodiments, the mixture and/or solid mass can further include an element selected from the group of Ti, Hf, Nb, Zr, Ta, W, Mo, V, U, Th, Sc, Be, Re, Rh, Ru, Ir, Os, Pt, and combinations thereof.

In one embodiment, the temperature of the process is about 1690° C. In another embodiment, the Si has a d95 of less than about 30 microns.

The present disclosure further provides a SiC bonded diamond compact prepared by the process described herein, wherein the SiC bonded diamond compact has an unreacted Si content of less than about 2 weight % and a graphite content of less than about 1 weight %. In some embodiments, the strength of the compact is at least about 700 MPa. In some embodiments, the SiC bonded diamond compact has an unreacted Si content is less than about 1.5 weight %. In other embodiments, the unreacted Si content is less than about 1 weight %. In still other embodiments, the SiC bonded diamond compact has a graphite content less than about 0.1 weight %.

In certain embodiments, the diamond compact is formed at a temperature of about 1690° C.

The present invention further provides a process for preparing a silicon carbide (“SiC”) bonded diamond compact. This process comprises sintering a mixture, the mixture including diamond, silicon (Si), and, optionally, at least one component selected from the group of Si₃N₄, AlN, hBN, and combinations thereof, wherein the sintering takes place at a pressure of about 10 to about 80 Kbar, at a temperature of from about 1400° C. to about 1600° C.; and wherein the d95 of the Si is less than about 30 μm.

In some embodiments, the mixture is in contact with a mass of solid or powered Si during the sintering. In some embodiments, the mixture and/or the mass of Si further includes an element selected from the group of Ti, Hf, Nb, Zr, Ta, W, Mo, V, U, Th, Sc, Be, Re, Rh, Ru, Ir, Os, Pt, and combinations thereof.

In some embodiments, the d95 of the Si is less than about 10 μm. In other embodiments, the d95 of the Si is about 7.5 μm. In some embodiments, the temperature of the sintering process is about 1600° C.

The present disclosure further provides a SiC bonded diamond compact prepared by the process disclosed herein, wherein the SiC bonded diamond compact has an unreacted Si content of less than about 2 weight % and a graphite content of less than about 1 weight %. In some embodiments, the strength of the compact is at least about 700 MPa.

In some embodiments, the unreacted Si content is less than about 1.5 weight %. In other embodiments, the unreacted Si content is less than about 1 weight %. In some embodiments, the graphite content is less than about 0.1 weight %. In some embodiments, the strength is at least about 800 MPa.

The present disclosure also provides a SiC bonded diamond compact comprising from about 60 to about 90 weight % diamond, about 10 to 40 weight % SiC, less than about 2 weight % unreacted Si, and less than about 1 weight % graphite.

In some embodiments, the diamond comprises about 81 to about 82 weight % of the compact; the SiC comprises about 17 to about 18 weight % of the compact; and the unreacted Si comprises less than about 1.1 weight % of the compact. In some embodiments, the unreacted Si comprises less than about 0.9 weight % of the SiC bonded diamond compact. In some embodiments, the graphite is less than about 0.1 weight %.

### BRIEF DESCRIPTION OF THE DRAWINGS

The foregoing summary, as well as the following detailed description of the embodiments, will be better understood when read in conjunction with the appended drawings. For the purpose of illustration, there are various embodiments shown in the drawings. It should be understood, however, that the embodiments depicted are not limited to the precise arrangements and instrumentalities shown.

FIG. 1 depicts a calibration curve correlating the power and measured temperature.

FIG. 2 depicts a contour plot of temperature vs. density, time.

FIG. 3 depicts a contour plot of Si weight % vs. temperature, time.

FIG. 4 depicts the relationship between sintering temperature and unreacted Si (weight %) in a SiC diamond compact for a given mixture of Si and diamond.

FIG. 5 depicts the relationship between the strength of a product prepared by the process described herein with the weight % of the unreacted Si in the product.

FIG. 6 is a graph showing the relationship between SiC diamond compact strength and particle size of the silicon powder used to produce the compact.

FIG. 7 is an optical micrograph of a diamond compact prepared according to the method described herein using silicon powder with d95 of 31 microns.

FIG. 8 is an optical micrograph of a diamond compact prepared according to the method described herein using silicon powder with d95 of 7.6 microns.

### DETAILED DESCRIPTION

Prior methods for preparing SiC bonded diamond compacts required reaction temperature below about 1600° C. for reaction times greater than about 5 minutes or reaction times of below about 5 minutes for reaction temperatures over about 1600° C. The necessity of these cycle times and temperatures was dictated by the preference to minimize graphitization of the diamond materials in the starting materials as well as to ensure more complete utilization of Si. The present disclosure provides a method of minimizing both silicon content and graphite content in a SiC bonded diamond compact using previously unreported cycle times, temperatures, and Si grain sizes.

In particular, the present disclosure provides a method of preparing a SiC bonded diamond compact with less than about 1 weight % residual graphite and less than about 2 weight % unreacted Si. In particular embodiments, the SiC diamond compact includes less than about 0.1 weight % graphite and has a Si content of less than about 1 weight %. The method comprises high pressure/high temperature (“HP/HT”) sintering a mixture of diamond, Si powder, and optionally, one or more additives selected from the group of Si₃N₄, AlN, and hexagonal boron nitride (hereafter “hBN”), wherein, optionally, the mixture has been brought into contact with a mass of Si prior to sintering. The mass of Si can be either solid or a powder. Sintering takes place in a high pressure cell.

Generally speaking, the starting material including a powdered mixture of Si, diamond, and optional additives (“the mixture”), can comprise from about 60 weight % to about 97 weight % diamond, with the balance of the mixture being Si, and, optionally, one of Si₃N₄, AlN, hBN, or some combination of Si₃N₄, AlN, hBN. In certain embodiments, the mixture of Si, diamond, and optional additives can further include at least one element selected from the group of Ti, Hf, Nb, Zr, Ta, W, Mo, V, U, Th, Sc, Be, Re, Rh, Ru, Ir, Os, Pt, Fe, Co, Ni, Mg, Ca, Al, Cr, Mn, and combinations thereof. Similarly, the mass of Si brought into contact with the mixture can optionally include at least one element selected from the group of Ti, Hf, Nb, Zr, Ta, W, Mo, V, U, Th, Sc, Be, Re, Rh, Ru, Ir, Os, Pt, Fe, Co, Ni, Mg, Ca, Al, Cr, Mn, and combinations thereof.

In certain embodiments, diamond content of the mixture can be from about 85 weight % to about 97 weight %. In other embodiments, diamond content can be about 90 weight % of the mixture. In certain embodiments, Si content can be from about 3 weight % to about 15 weight % of the mixture. In further embodiments, Si content can be about 10 weight % of the mixture. In certain embodiments, Si₃N₄ content can be from about 0.1 weight % to about 2 weight % of the mixture, and in particular embodiments, about 0.5 weight % of the mixture. Alternatively, Si₃N₄ can be present with AlN and hBN, wherein Si₃N₄, AlN, and hBN in total can comprise from about 0.1 weight % to about 2 weight % of the mixture, and in particular embodiments, about 0.5 weight % of the mixture. In some embodiments, when an element selected from the group of Ti, Hf, Nb, Zr, Ta, W, Mo, V, U, Th, Sc, Be, Re, Rh, Ru, Ir, Os, Pt, Fe, Co, Ni, Mg, Ca, Al, Cr, Mn, and combinations thereof is present in the mixture, the element or combination of elements may not exceed about 1 weight % of the mixture.

Many sizes, shapes, and grades of diamond are commercially available. The appropriate diamond component for the powder mixture can be selected by a person of ordinary skill in the art according to the requirements of the application for which the SiC bonded diamond compact is being prepared. In particular embodiments, the mean grain size of the diamond component of the mixture can be from about 0.5 μm to about 100 μm. In particular embodiments all of the diamonds in a given mixture can have approximately the same size. In other embodiments, the diamond sizing in a given mixture can be bimodal (i.e. a mixture of diamonds having two materially different grain sizes, such as, for example 5 and 21 microns), trimodal (i.e. a mixture of diamonds having three materially different grain sizes, such as, for example, 5, 21, and 30 microns), or possess other desired variations in size.

The grain size of the Si component of the mixture can be any nominal size, but in certain embodiments is selected to be appreciably smaller than the primary diamond grain size. For example, in certain embodiments, the mean Si grain size can be from about 0.5 μm to about 20 μm. In addition, the particle size distribution of the Si component of the mixture is such that d95 is less than about 31 μm. In certain embodiments of the invention, the Si component of the mixture can be crystalline Si. The Si can, however, be amorphous, a liquid or it can be a silicon-bearing material (precursor) that reacts during processing to supply Si.

In particular embodiments, the d95 of the Si component of the mixture can be less than about 31 μm. In other embodiments, the d95 is less than about 15 μm. In other embodiments, the d95 is less than about 10 μm. In a particular embodiment, the d95 is about 7.5 μm. In a further embodiment, the d95 is less than about 5 μm. While there is no necessity to correlate diamond and silicon size, in certain embodiments, the d95 of the Si component can be selected to be about half the size of the average diamond particle size.

The constituents (starting materials) of the mixture are subjected to ball milling, hand mixing, or any other suitable mixing technique known to a person of ordinary skill in the art to form a homogenous powder. Subsequently, a pre-determined amount of the mixture is loaded into a container and densified by manual compaction.

Alternatively, the homogenous powder can be mixed with a suitable binder, optionally granulated using a spray drying, freeze granulation, or other granulating technique, pressed into a pill or other shape, and then fired to remove the binder and develop strength in the powdered mixture. The resultant mixture can then be loaded into a container.

Once the mixture is packed, regardless of methodology, an optional mass of solid or powdered silicon is placed adjacent to or otherwise in communication with the mixture, and the container is closed with a lid. The filled and closed container is then loaded into a pressure cell for HP/HT processing.

In certain embodiments, the pressure for the HP/HT processing is from about 10 to about 80 kBar. In certain embodiments, the pressure is from about 10 to about 50 kBar. In other embodiments, the pressure is from about 20 to about 40 Kbar. In still other embodiments, the pressure is about 30 Kbar. In certain embodiments, the temperature of the process exceeds about 1600° C. and can reach as high as about 1800° C., including all whole and partial increments there between. In particular embodiments, the temperature can be greater than about 1650° C. In other embodiments, the temperature can be about 1690° C. For temperatures above about 1600° C., the sintering time can be greater than about 5 minutes, in certain embodiments greater than about 15 minutes, and in other embodiments greater than about 25 minutes. In particular embodiments, the sintering time can be about 30 minutes, about 35 minutes, or even about 40 minutes. Sintering times are limited only by the costs associated with the sintering process.

Despite the longer sintering times for temperatures above 1600° C., little to no graphitization of the diamond starting materials was observed as measured by an x-ray diffraction (“XRD”) scan of the (0 0 2) graphite peak of the resultant products. In embodiments where graphite was detected, graphite was less than about 1 weight % of the final product, and in certain embodiments, less than about 0.5 weight %. In other embodiments, the amount of graphite present in the diamond compact was less than about 0.25 weight %, less than about 0.15 weight %, or even less than about 0.1 weight %.

A SiC bonded diamond compact prepared according to the above described procedure can contain a non-zero amount of Si of less than about 2 weight % unreacted Si, in certain embodiments less than about 1.4 weight % unreacted Si, in other embodiments less than about 1.2 weight % unreacted Si, and in a further embodiment, less than about 1 weight % unreacted Si.

In certain embodiments of the method described herein, when the temperature of the HP/HT process is in the range of about 1400° C. to about 1600° C., and with the sintering times as described above, the d95 of the silicon powder can be less than about 31 μm, in certain embodiments, from about 5 μm to about 20 μm, and in a further embodiment less than about 5 μm.

Compacts produced by the above described process possess greatly increased tensile strength, i.e. greater than about 675 MPa, as measured by 3 point bend flexural strength tests. Without wishing to be bound to any particular theory, it is believed that the increased strength of the compacts produced by the present method is due to reduced levels of un-reacted silicon, the reduced size of un-reacted silicon grains, a reduction in the quantity of graphite in the product, or some combination of these factors.

Diamond compacts according to the invention can comprise from about 60 to about 95 weight % diamond, from about 40 to about 5 weight % SiC, less than about 2 weight % unreacted Si, and less than about 1 weight % graphite. In a particular embodiment, the SiC bonded diamond compact produced by the method described herein can comprise about 81 to about 82 weight % diamond, about 17 to about 18 weight % SiC, about 1.1 weight % or less silicon, and less than about 0.1 weight % graphite. In a further embodiment, wherein the SiC bonded diamond compact is prepared using silicon powder with a d5 of about 0.3 to about 0.7 microns, a d50 of about 2.5 to about 3.5 microns, and a d95 of about 5 to about 10 microns, the composition can comprise about 81 to about 82 weight % diamond, about 17 to about 18% SiC, about 1 weight % or less silicon, and less than about 0.1 weight % graphite.

### DEFINITIONS

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

### EXAMPLES

The method disclosed herein is now further detailed with reference to the following examples. These examples are provided for the purpose of illustration only, and the method disclosed herein should in no way be construed as being limited to these examples but rather should be construed to encompass any and all variations which become evident as a result of the teaching provided herein.

X-ray diffraction was used to determine the amounts (reported in % by weight) of diamond, SiC, Si, and graphite present in the diamond compacts described herein. Diffraction patterns were collected using a Bruker AXS D8 diffractometer with Cu k-α radiation and a Solex solid state detector. Diffracted intensities of the diamond (1 1 1), SiC (1 1 1) and (2 0 0), Si (1 1 1), and graphite (0 0 2) peaks were obtained by peak fitting and used to calculate the material composition using Jade software, Easy Quantitative analysis. In typical diffraction experiments, data was collected in 0.02 degree steps. For the Si and graphite peaks, data was collected for 5 seconds per step, and for the diamond and SiC peaks, data was collected for 2 seconds per step.

Where density of the diamond compacts is reported, it was measured using the hydrostatic weighing method based on Archimedes' principle, using water as the buoyant medium, with corrections applied for water temperature.

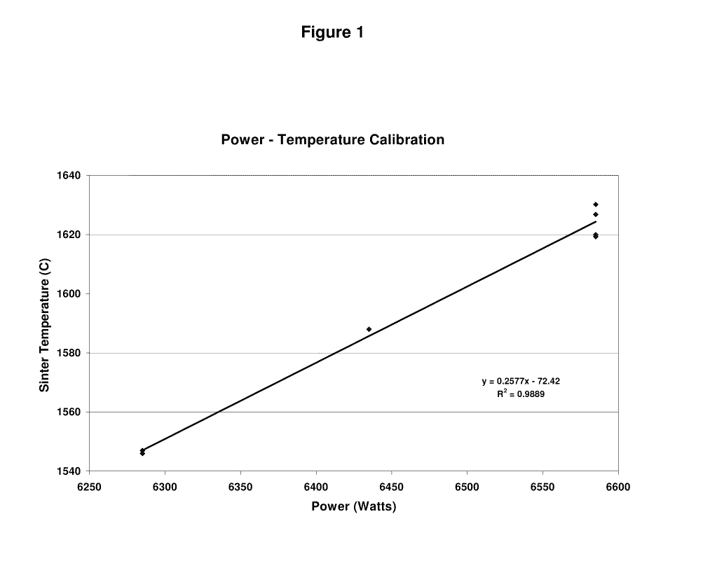

Temperatures were not measured directly for the experiments reported herein. Instead, the temperature of a given run was calculated based on the power (wattage) supplied to the heater circuit during the run. A power-temperature calibration curve was measured by performing a series of press runs, using a range of wattage set points, and therefore, a range of reaction temperatures. These runs utilized a thermocouple embedded within the center of a slightly modified cell not suitable for standard runs. The calibration curve correlating the power and the measured temperature is shown in FIG. 1.

### Example 1

A series of diamond compacts were produced using a blend of 72 weight % diamond with a 21 micron average particle size, 18 weight % diamond with a 5 micron average particle size, 9.5 weight % silicon with a PSD characterized by a d5, d50, and d95 of 5.8, 15, and 31 microns, respectively, and 0.5 weight % of Si₃N₄ with a 1 micron average size.

The powder blend described above was separately loaded into 10 pressure cells.

The cells were then pressed at 30 kBar at different sintering temperatures and for different amounts of time. The time and temperature of the sintering processes are shown in Table 1. Table 1 further includes the density of the resultant product, the weight % unreacted Si in the resultant product, and strength of the resultant compact (MPa) (average of three strength measurements per sinter condition).

Strength was measured in 3-point bending by preparing test bars using a wire EDM. The bars measured 3 mm×4 mm×30 mm. The surfaces of the bars were not ground, lapped, polished, or treated in any way after being machined. The bars were tested in flexure using a crosshead speed of 1.27 mm/min on a 3-pt. bend fixture with a 20 mm span. The strengths reported were calculated from the maximum load obtained and the test geometrical details.

TABLE 1
Processing Conditions and Diamond Compact Properties

| Sinter | Sinter Temp | Sinter Time | Density | | Strength |
|---|---|---|---|---|---|
| Power (W) | (C.) | (min.) | (g/cm³) | Si (Wt. %) | (MPa) |
| 6241 | 1538 | 30 | 3.392 | 2.2 | 648 |
| 6345 | 1565 | 24 | 3.392 | 2.1 | 614 |
| 6345 | 1565 | 36 | 3.397 | 2.0 | 633 |
| 6595 | 1630 | 30 | 3.398 | 1.8 | 637 |
| 6595 | 1630 | 21.5 | 3.402 | 1.5 | 622 |
| 6595 | 1630 | 38.5 | 3.404 | 1.5 | 637 |
| 6595 | 1630 | 30 | 3.404 | 1.5 | 633 |
| 6845 | 1694 | 24 | 3.406 | 1.3 | 617 |
| 6845 | 1694 | 36 | 3.411 | 1.1 | 706 |
| 6949 | 1721 | 30 | 3.412 | 1.1 | 699 |

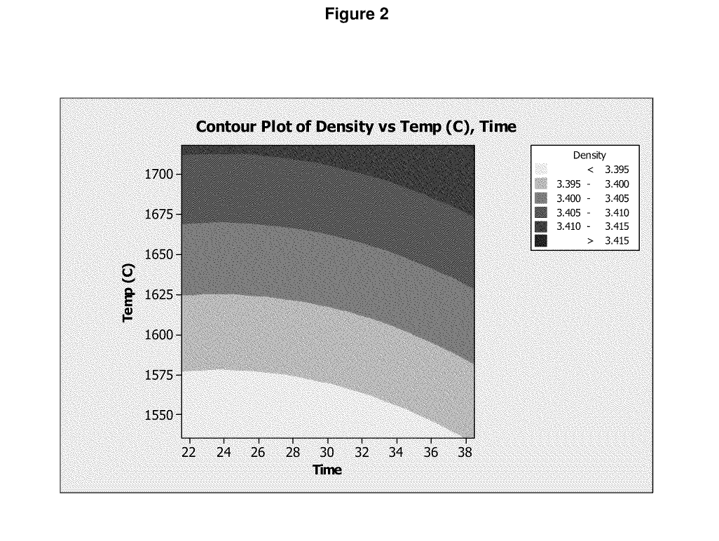

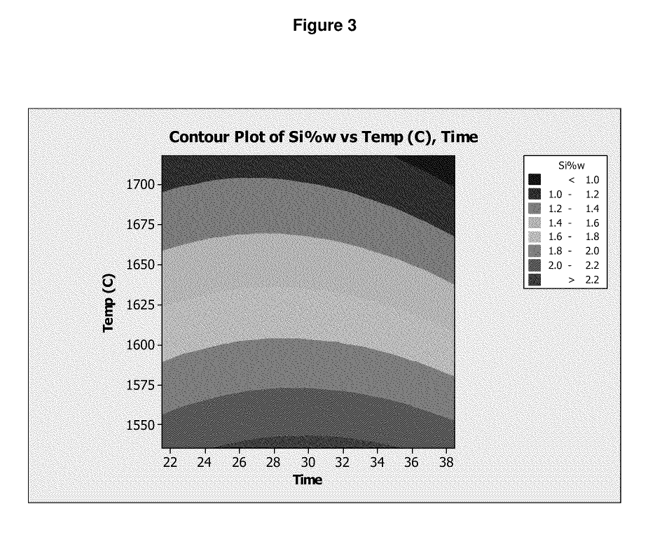

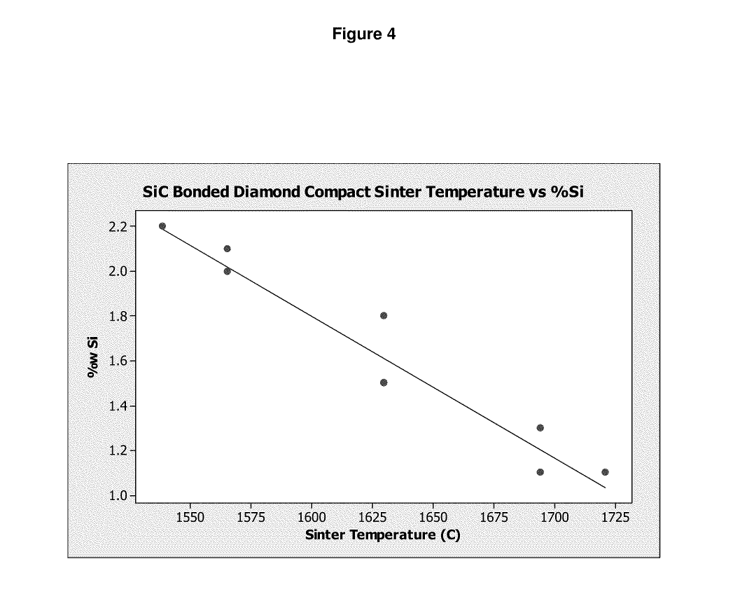

Contour plots of the relationships between density and weight % Si are shown in FIGS. 2 and 3. The contour plots show that the effect of temperature is greater than the effect of time over these ranges, in controlling the density and the amount of unreacted Si in a given product. A graph of the results shown in Table 1 is provided in FIG. 4. This graph clearly shows a linear relationship between sintering temperature and unreacted Si content.

Following sintering, several of the above described products were tested for strength. In particular, samples produced at sintering temperatures of 1724° C., and 1731° C. were analyzed. The average strength of these two diamond compacts was about 703 MPa with a standard deviation of 5 MPa. These two samples had an average unreacted silicon content of 1.1 weight %.

By way of comparison, the average strength of the other diamond compacts in Table 1 was about 630 MPa with a standard deviation of 12 MPa. These samples contained 1.3 to 2.2 weight % Si. A 2-sample t-test performed on these data indicated that the strengths of the two groups were significantly different, with 95% confidence that the difference was at least 57 MPa.

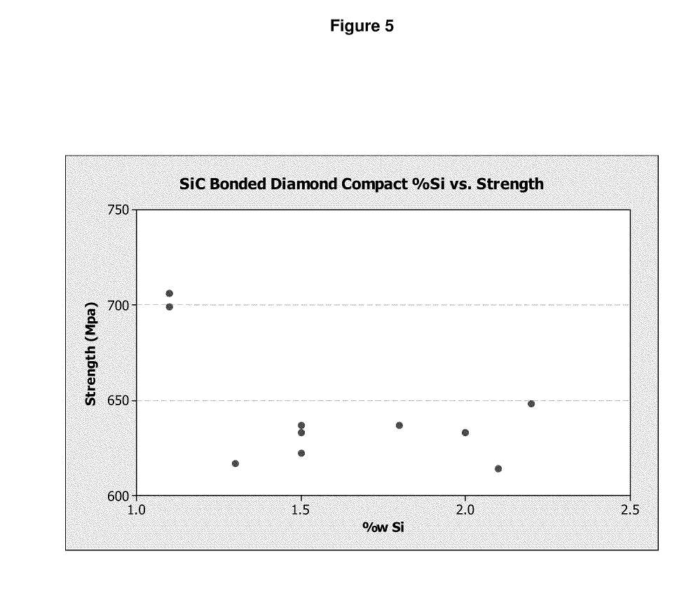

The results of the strength tests of the various samples produced in Table 1 are plotted in FIG. 5. The data in FIG. 5 show that the strength improvements follow a “threshold” relationship (step function), with diamond compacts containing less than about 1.3 weight % Si having greatly improved strength compared to diamond compacts having greater than about 1.3 weight % Si. This highly non-linear relationship between Si content and strength was very surprising and suggested that efforts to reduce unreacted Si even more could provide even greater benefits.

### Example 2

### Effect of Si Particle Size

A diamond compact was produced using a blend of 72 weight % diamond with a 21 micron average size, 18 weight % diamond with a 5 micron average size, 9.5 weight % silicon with a PSD characterized by d5, d50, and d95 of 0.5, 3.0, and 7.6 microns, respectively, and 0.5% of Si₃N₄ with a 1 micron average size. The powder blend was loaded into a pressure cell as described in Example 1. The cell was pressed using sintering conditions of about 1600° C. and 30 kBar, with a sintering time of 30 minutes.

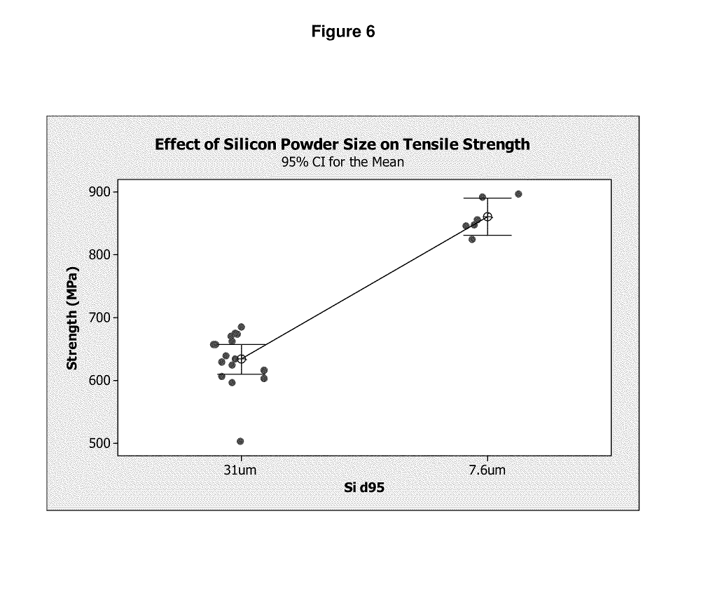

Three additional diamond compacts were produced using the same methods and materials described for the sample prepared using a Si characterized by a d95 of 7.6 microns, except that silicon having a PSD characterized by a d5, d50, and d95 of 5.8, 15, and 31 microns, respectively, was used. Comparative properties of the resultant materials are shown in Table 2 and FIG. 6.

TABLE 2

| Si d95 | Density | | Strength |
|---|---|---|---|
| (um) | (g/cm³) | Si (% wt) | (MPa) |
| 7.6 | 3.424 | 0.8 | 847 |
| | | | 855 |
| | | | 844 |
| | | | 823 |
| | | | 890 |
| | | | 895 |
| 31 | 3.409 | 1.3 | 685 |
| | | | 675 |
| | | | 662 |
| | | | 669 |
| | 3.401 | 1.9 | 638 |
| | | | 596 |
| | | | 633 |
| | | | 656 |
| | | | 624 |
| | | | 672 |
| | 3.404 | 1.7 | 606 |
| | | | 603 |
| | | | 657 |
| | | | 629 |
| | | | 503 |
| | | | 616 |

The average strength of a diamond compact with a silicon powder PSD characterized by d95 of 7.6 microns, was 859 MPa with a standard deviation of 28 MPa. The sample corresponding to these strength measurements had an average unreacted silicon content of 0.8% by weight. By way of comparison, the average strength for diamond compacts made using silicon powder with a PSD characterized by d95 of 31 microns was 633 MPa with a standard deviation of 44 MPa. These SiC bonded diamond compacts had an unreacted silicon content of between about 1.3 to about 1.9% by weight. A 2-sample t-test performed on these data indicated that the strengths of the two groups were significantly different, with 95% confidence that the difference was at least 185 MPa.

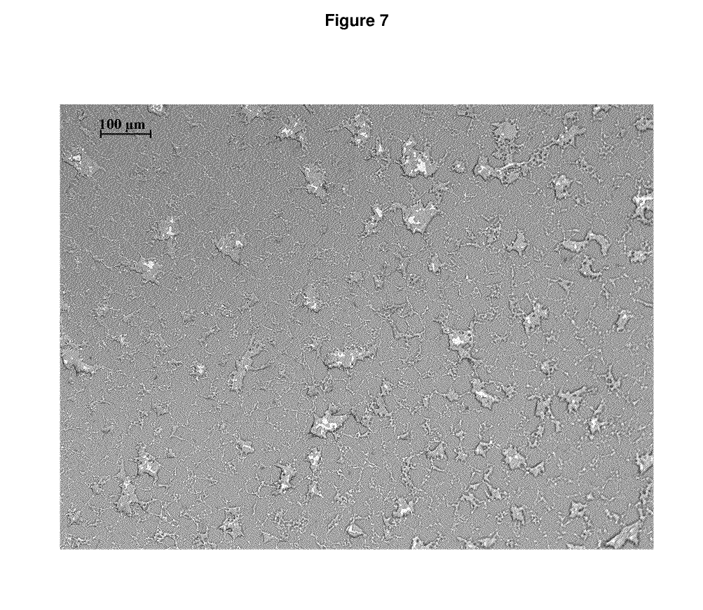

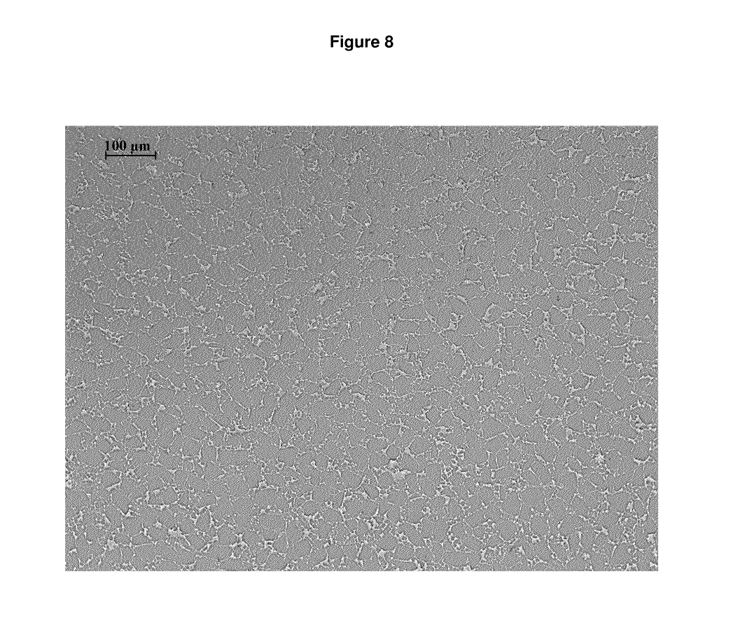

FIGS. 7 and 8 are optical micrographs of the SiC bonded diamond compacts prepared using Si powders having a d95 of 31 and 7.6 microns, respectively. White areas in the micrographs correspond to elemental Si, the light gray continuous phase is SiC, and the dark gray grains are diamond.

The compacts pictured in the micrographs are characterized as having densely packed diamond crystals surrounded by the SiC reaction product. The compacts also contain structures that are the remnants of the Si powder used in the mixture to produce the compacts. These remnants (hereafter referred to as SiC/Si grains) are areas containing SiC and Si which are relatively devoid of diamond crystals. The largest of these SiC/Si grains are believed to be remnants of the largest Si powder particles used in the mixture. The remnants can be characterized by the size (largest extent in a single direction) of the SiC/Si grain and the size (largest extent in a single direction) of the Si grains.

A quantitative analysis of the grain size of SiC/Si grains and unreacted Si grains of the samples shown in FIGS. 7 and 8 are shown in Table 3.

TABLE 3
Grain Size in Microns

| | Diamond Size | | | |
|---|---|---|---|---|
| | 80% 21 micron and 20% 5 micron | | | |
| | Si Size | | | |
| | d95 = 31 microns | | d95 = 7.6 microns | |
| Feature Measured | Si Grain | SiC/Si Grain | Si Grain | SiC/Si Grain |
| Size (microns) | 5.1 | 26.1 | 1.9 | 13.6 |
| | 5.7 | 51.7 | 2.5 | 10.0 |
| | 5.9 | 30.2 | 2.0 | 16.7 |
| | 5.1 | 12.7 | 2.3 | 13.3 |
| | 4.3 | 45.3 | 2.6 | 15.0 |
| | 1.2 | 41.0 | 2.6 | |
| | 6.0 | 35.0 | 1.2 | |
| | 7.1 | 67.2 | 1.3 | |
| | 8.2 | 22.5 | 1.3 | |
| | 3.8 | 30.2 | 1.9 | |
| | 4.2 | 26.9 | 2.8 | |
| | 14.2 | | 2.0 | |
| | 6.0 | | 2.3 | |
| | 7.0 | | 2.0 | |
| | 5.5 | | 1.4 | |
| | 9.8 | | 1.9 | |
| | | | 3.4 | |
| Maximum | 14.2 | 67.2 | 3.4 | 16.7 |
| Average | 6.2 | 35.3 | 2.1 | 13.7 |
| St. Dev. | 2.9 | 15.2 | 0.6 | 2.5 |

The largest unreacted Si particle observed using the Si having a d95 of 31 microns was 14.2 microns. The corresponding size of unreacted Si particles using Si having a d95 of 7.6 microns was 3.4 microns. This is a reduction in the largest unreacted Si particle size by a factor of 4.12, corresponding well with the ratio of the d95 of the starting Si used in each case (31 microns/7.6 microns=4.08). A similar phenomenon was observed when comparing the largest SiC/Si grain sizes of the resultant compact.

While reference has been made to specific embodiments, it is apparent that other embodiments and variations can be devised by others skilled in the art without departing from their spirit and scope. The appended claims are intended to be construed to include all such embodiments and equivalent variations.

1. A process for preparing a silicon carbide (“SiC”) bonded diamond compact, said process comprising sintering a mixture, said mixture including diamond, silicon (Si), and, optionally, at least one component selected from the group of Si₃N₄, AlN, hBN, and combinations thereof,
wherein
said sintering takes place at a pressure of about 10 to about 80 Kbar;
at a temperature of from about 1600° C. to about 1800° C.; and
wherein said sintering takes place for at least about 10 minutes.

2. The process of claim 1, wherein said mixture is in contact with a mass of solid or powered Si during said sintering.

3. The process of claim 1, wherein said mixture further includes an element selected from the group of Ti, Hf, Nb, Zr, Ta, W, Mo, V, U, Th, Sc, Be, Re, Rh, Ru, Ir, Os, Pt, and combinations thereof.

4. The process of claim 2, wherein said mass of solid or powdered Si further includes an element selected from the group of Ti, Hf, Nb, Zr, Ta, W, Mo, V, U, Th, Sc, Be, Re, Rh, Ru, Ir, Os, Pt, and combinations thereof.

5. The process of claim 1, wherein the Si has a d95 of less than about 30 microns.

6. The process of claim 1, wherein the temperature is about 1690° C.

7. A SiC bonded diamond compact prepared by the process of claim 1, wherein said SiC bonded diamond compact has an unreacted Si content of less than about 2 weight % and a graphite content of less than about 1 weight %.

8. The SiC bonded diamond compact of claim 7, wherein the strength of said compact is at least about 700 MPa.

9. The SiC bonded diamond compact of claim 7, wherein said unreacted Si content is less than about 1.5 weight %.

10. The SiC bonded diamond compact of claim 9, wherein said unreacted Si content is less than about 1 weight %.

11. The SiC bonded diamond compact of claim 7, wherein said graphite content is less than about 0.1 weight %.

12. The SiC bonded diamond compact of claim 7, wherein said temperature is about 1690° C.

13. A process for preparing a silicon carbide (“SiC”) bonded diamond compact, said process comprising sintering a mixture, said mixture including diamond, silicon (Si), and, optionally, at least one component selected from the group of Si₃N₄, AlN, hBN, and combinations thereof,
wherein
said sintering takes place at a pressure of about 10 to about 80 Kbar;
at a temperature of from about 1400° C. to about 1600° C.; and
wherein the d95 of the Si is less than about 30 μm.

13. The process of claim 13, wherein said mixture is in contact with a mass of solid or powered Si during said sintering.

14. The process of claim 13, wherein said mixture further includes an element selected from the group of Ti, Hf, Nb, Zr, Ta, W, Mo, V, U, Th, Sc, Be, Re, Rh, Ru, Ir, Os, Pt, and combinations thereof.

15. The process of claim 14, wherein said mass of solid or powdered Si further includes an element selected from the group of Ti, Hf, Nb, Zr, Ta, W, Mo, V, U, Th, Sc, Be, Re, Rh, Ru, Ir, Os, Pt, and combinations thereof.)

16. The process of claim 13, wherein the d95 of the Si is less than about 10 μm.

17. The process of claim 16, wherein the d95 of the Si is about 7.5 μm.

18. The process of claim 13, wherein the temperature is about 1600° C.

19. A SiC bonded diamond compact prepared by the process of claim 13, wherein said SiC bonded diamond compact has an unreacted Si content of less than about 2 weight % and a graphite content of less than about 1 weight %.

20. The SiC bonded diamond compact of claim 19, wherein the strength of said compact is at least about 700 MPa.

21. The SiC bonded diamond compact of claim 19 wherein said unreacted Si content is less than about 1.5 weight %.

22. The SiC bonded diamond compact of claim 21, wherein said unreacted Si content is less than about 1 weight %.

23. The SiC bonded diamond compact of claim 22, wherein said graphite content is less than about 0.1 weight %.

24. The SiC bonded diamond compact of claim 19, wherein said strength is at least about 800 MPa.

25. A SiC bonded diamond compact comprising from about 60 to about 95 weight % diamond, about 10 to 40 weight % SiC, less than about 2 weight % unreacted Si, and less than about 1 weight % graphite.

26. The SiC bonded diamond compact of claim 25, wherein said diamond comprises about 81 to about 82 weight % of the compact; said SiC comprises about 17 to about 18 weight % of the compact; and said unreacted Si comprises less than about 1.5 weight % of the compact.

27. The SiC bonded diamond compact of claim 25, wherein said unreacted Si comprises less than about 0.9 weight % of said SiC bonded diamond compact.

28. The SiC bonded diamond compact of claim 25, wherein said graphite is less than about 0.1 weight %.

29. The SiC bonded diamond compact of claim 25, wherein the strength of said compact is at least about 700 MPa.

30. The SiC bonded diamond compact of claim 25, wherein said unreacted Si content is less than about 1.1 weight %.

31. A SiC bonded diamond compact according to claim 25, as herein described with reference to Example 1.

32. A process for repairing a silicon carbide (“SiC”) bonded diamond compact according to claim 25 as herein described with reference to Example 1.
